(19) United States
(12) Patent Application Publication
(10) Pub. No.: US 2024/0220528 A1
(43) Pub. Date: Jul. 4, 2024

(54) SYSTEM AND METHOD FOR GENERATING ONTOLOGIES FOR ENHANCED SEARCH

(71) Applicant: Innoplexus AG, Eschborn (DE)

(72) Inventors: Arpan Sheetal, Hazaribag (IN); Sudhanshu Kumar, Bokaro (IN)

(73) Assignee: Innoplexus AG, Eschborn (DE)

(21) Appl. No.: 18/149,931

(22) Filed: Jan. 4, 2023

(51) Int. Cl. G06F 16/36; G06F 16/31; G06F 16/906; G06F 16/953; G06F 16/954; G06F 16/958

(52) U.S. Cl. CPC G06F 16/367; G06F 16/313; G06F 16/906; G06F 16/953; G06F 16/954; G06F 16/958

(57) ABSTRACT

A method of generating an ontology for enhanced search is disclosed that includes an iterative process. The method includes loading seed entities in a memory and using a look-up API to search a first set of similar terms for each seed entity from a web-based database. The first set of similar terms is then clustered based on different concepts to obtain a first cluster of similar terms. The method further includes determining a second set of similar terms for each seed entity based on a category of each seed entity. The second set of similar terms is then clustered based on the different concepts to obtain a second cluster of similar terms. The first and second clusters are merged to generate the ontology of the seed entities. The iterative process is repeated until a saturation point is reached, at which point the generated ontology is considered complete.

### FIELD OF TECHNOLOGY

The present disclosure relates generally to generating ontologies, and more specifically, to a system and a method for generating ontologies for enhanced search.

### BACKGROUND

World wide web (Web) allows access to data pertaining to one or more domains to people around the globe. The data pertaining to a domain may be analyzed and searched using several searching methods or applications. However, while searching for an input term or phrase pertaining to domain, some of the data pertaining to the same domain may get missed or may not be retrieved due to inadequacy of such searching methods or applications. Finding and identifying similar terms, synonyms, and alternate terms for concepts within a particular domain of knowledge may be a time-consuming and labor-intensive process, especially when dealing with large numbers of terms or when attempting to identify relationships between different concepts. The data includes one or more synonyms and other similar terms of the input term or phrase. Conventionally, an open-source software may be used to retrieve one or more synonyms and other similar terms for an input term. However, such open-source software is restricted to non-domain specific terms.

Typically, for analyzing data pertaining to a domain in a conventional search engine or a data warehouse, it is important to form an ontology. In computing and information science technology, the ontology is a way of showing the properties of a technical subject area and how they are related, by defining a set of categories that represent the subject. In other words, the ontology is a formal description of knowledge as a set of terms within a domain and the relationships that are held between them. For instance, there are many different terms that can be used to describe the same things in various data sets. Ontologies can identify these relationships and make it easier to determine the semantics of such data sets. Unfortunately, constructing ontologies is a labor intensive and costly process. In addition, ontologies are often incomplete and unfocused.

Further limitations and disadvantages of conventional and traditional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a system and a method for generating an ontology for enhanced search. The present disclosure seeks to provide a solution to the existing problem of finding and identifying similar terms, synonyms, and alternate terms for concepts within a particular domain of knowledge, such as scientific research. Finding and identifying similar terms, synonyms, and alternate terms for concepts within a particular domain of knowledge may be a time-consuming and labor-intensive process, especially when dealing with large numbers of terms or when attempting to identify relationships between different concepts. An aim of the present disclosure is to provide a solution that overcomes at least partially the problems encountered in prior art and provide an improved system and method for generating an ontology for enhanced search in a way such that all similar terms, synonyms, and alternate terms for concepts within the particular domain of knowledge may be easily searched and identified.

In one aspect, the present disclosure provides a method for generating an ontology for enhanced search, the method comprising:
loading, by a processor, a plurality of seed entities in a memory communicatively coupled with the processor;
causing, by the processor, a look-up application programming interface (API) to search a first set of similar terms for each seed entity of the plurality of seed entities from a web-based database;
executing, by the processor, a first clustering of the first set of similar terms for each seed entity based on a plurality of different concepts to obtain a first cluster of similar terms;
determining, by the processor, a second set of similar terms for each seed entity of the plurality of seed entities based on a category of each seed entity of the plurality of seed entities;
executing, by the processor, a second clustering of the second set of similar terms for each seed entity based on the plurality of different concepts to obtain a second cluster of similar terms;
merging, by the processor, the first cluster of similar terms and the second cluster of similar terms to generate the ontology of the plurality of seed entities and form an ontology database based on the generated ontology; and integrating, by the processor, the ontology database in a search engine.

The method disclosed in the present disclosure allows for the creation of an ontology that may be used to organize and categorize concepts, synonyms, and alternate terms within a particular domain of knowledge. The generated ontology may then be integrated into a search engine, making it easier for researchers and scientists to find and understand the relationships between different concepts and terms within their field. Another advantage of the method of the present disclosure is that the method may help researchers to identify and discover new tools, techniques, and concepts that are related to their work. This may be especially useful for researchers who are working in rapidly evolving fields, where new technologies and approaches are being developed all the time.

Further, the use of the generated ontology as described in the present disclosure may help to improve the efficiency and effectiveness of scientific research, by providing a more organized and comprehensive view of the concepts and tools that are relevant to a particular field of study.

In another aspect, the present disclosure provides a system for generating an ontology for enhanced search, the system comprising:
a memory; and
a processor communicatively coupled with the memory, wherein the processor is configured to:
   load a plurality of seed entities in the memory;
   cause a look-up application programming interface (API) to search a first set of similar terms for each seed entity of the plurality of seed entities from a web-based database;
   execute a first clustering of the first set of similar terms for each seed entity of the plurality of seed entities based on a plurality of different concepts to obtain a first cluster of similar terms;
   determine a second set of similar terms for each seed entity of the plurality of seed entities based on a category of each seed entity of the plurality of seed entities;
   execute a second clustering of the second set of similar terms for each seed entity based on the plurality of different concepts to obtain a second cluster of similar terms;
   merge the first cluster of similar terms and the second cluster of similar terms to generate the ontology of the plurality of seed entities and form an ontology database based on the generated ontology; and integrate the ontology database in a search engine.

The system achieves all the advantages and technical effects of the method of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a system for generating an ontology for enhanced search, in accordance with an embodiment of the present disclosure;

FIG. 2 is a block diagram of another system for generating an ontology for enhanced search, in accordance with an embodiment of the present disclosure;

FIG. 3 depicts a flowchart for generating an ontology for enhanced search, in accordance with an embodiment of the present disclosure; and

FIG. 4 is a flowchart of a method for generating an ontology for enhanced search, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

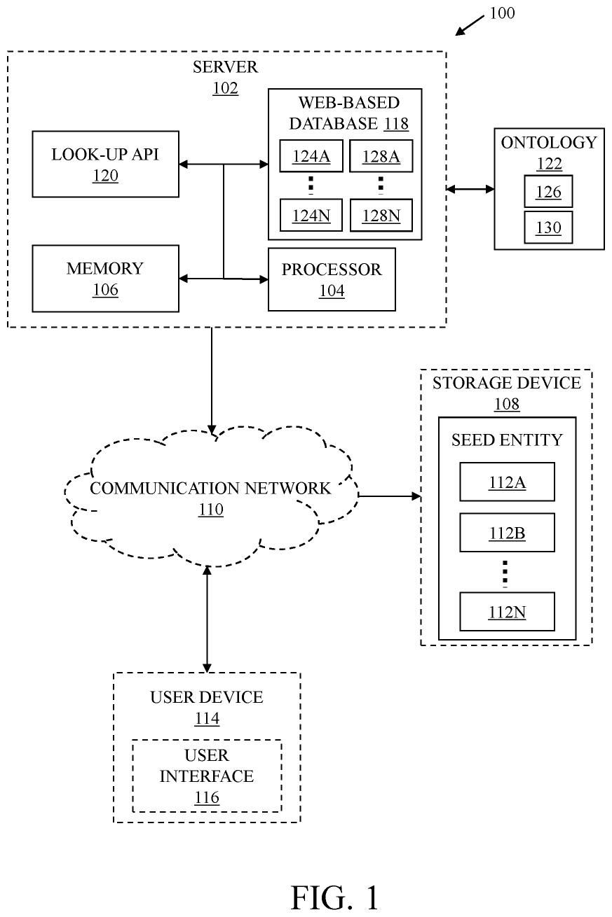

FIG. 1 is a block diagram of a system for generating an ontology for enhanced search, in accordance with an embodiment of the present disclosure. With reference to FIG. 1, there is shown a block diagram of a system 100. The system 100 includes a server 102, a processor 104, and a memory 106 communicably coupled to the processor 104. The server 102 includes the processor 104 and the memory 106.

In an implementation, the processor 104 and the memory 106 may be implemented on the server 102. In some implementations, the system 100 further includes a storage device 108 communicably coupled to the server 102 via a communication network 110. The storage device 108 includes a plurality of seed entities 112A to 112N. In some other implementations, the plurality of seed entities 112A to 112N may also be stored in the same server, such as the server 102. The plurality of seed entities 112A to 112N refers to a plurality of terms or phrases representing one or more tools and techniques in a structured way. The plurality of seed entities 112A to 112N may be retrieved from a small set of documents that may be web pages, blogs, publications, news articles, and the like. In an example, the plurality of seed entities 112A to 112N may be retrieved manually by a user. In another example, the plurality of seed entities 112A to 112N may be retrieved automatically by the processor 104. The server 102 may be communicably coupled to a plurality of user devices, such as a user device 114, via the communication network 110. The user device 114 includes a user interface 116.

In an implementation, the processor 104 may be communicatively coupled with a web-based database 118. The web-based database 118 includes similar terms for each seed entity of the plurality of seed entities 112A to 112N. Moreover, the processor 104 may be communicatively coupled with a look-up application programming interface (API) 120.

The present disclosure provides the system 100 for generating an ontology 122 for enhanced search, where the system 100 searches a plurality of similar terms from the web-based database 118 and clusters the plurality of similar terms based on different concepts to generate the ontology 122. The ontology 122 may refer to a set of concepts pertaining to a particular field or domain and the one or more similar terms associated with each of the set of concepts. In an example, the ontology 122 may be structured in a predetermined format. The predetermined format for the ontology 122 may be defined as a specified format of arranging the one or more similar terms with a corresponding concept identifier (e.g., an elastic search format). The predetermined format for an exemplary ontology (similar to the ontology 122) is provided as shown below.

S1, S2, S3 . . . . Sn=>Cn, where Cn depicts a concept identifier of a concept and S1. S2, S3 . . . Sn depicts “n” number of similar terms associated with the concept identifier of the concept i.e., Cn. In some examples, Cn may depict cluster identifier.

The server 102 includes suitable logic, circuitry, interfaces, and code that may be configured to communicate with the user device 114 via the communication network 110. In an implementation, the server 102 may be a master server or a master machine that is a part of a data center that controls an array of other cloud servers communicatively coupled to it for load balancing, running customized applications, and efficient data management. Examples of the server 102 may include, but are not limited to a cloud server, an application server, a data server, or an electronic data processing device.

The processor 104 refers to a computational element that is operable to respond to and processes instructions that drive the system 100. The processor 104 may refer to one or more individual processors, processing devices, and various elements associated with a processing device that may be shared by other processing devices. Additionally, the one or more individual processors, processing devices, and elements are arranged in various architectures for responding to and processing the instructions that drive the system 100. In some implementations, the processor 104 may be an independent unit and may be located outside the server 102 of the system 100. Examples of the processor 104 may include but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The memory 106 refers to a volatile or persistent medium, such as an electrical circuit, magnetic disk, virtual memory, or optical disk, in which a computer can store data or software for any duration. Optionally, the memory 106 is a non-volatile mass storage, such as a physical storage media. The memory 106 is configured to store the plurality of seed entities 112A to 112N. Furthermore, a single memory may encompass and, in a scenario, and the system 100 is distributed, the processor 104, the memory 106 and/or storage capability may be distributed as well. Examples of implementation of the memory 106 may include, but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

The storage device 108 may be any storage device that stores data and applications without any limitation thereto. In an implementation, the storage device 108 may be a cloud storage, or an array of storage devices.

The communication network 110 includes a medium (e.g., a communication channel) through which the user device 114 communicates with the server 102. The communication network 110 may be a wired or wireless communication network. Examples of the communication network 110 may include, but are not limited to, Internet, a Local Area Network (LAN), a wireless personal area network (WPAN), a Wireless Local Area Network (WLAN), a wireless wide area network (WWAN), a cloud network, a Long-Term Evolution (LTE) network, a plain old telephone service (POTS), a Metropolitan Area Network (MAN), and/or the Internet.

The user device 114 refers to an electronic computing device operated by a user. The user device 114 may be configured to obtain a user input of one or more words in a search engine rendered over the user interface 116 and communicate the user input to the server 102. The server 102 may then be configured to retrieve each similar term or unstructured text related to the one or more words. The one or more words is searched in a generated ontology 122 in order to find each similar term or the unstructured text related to the one or more words. Examples of the user device 114 may include, but not limited to, a mobile device, a smartphone, a desktop computer, a laptop computer, a Chromebook, a tablet computer, a robotic device, or other user devices.

The web-based database 118 refers to a database that is accessible via the internet, typically through a web browser. The web-based database 118 may allow users to access and manipulate data stored in the database over the internet, rather than through a local computer or network. The web-based database 118 may include structured data, unstructured data, or semi structured data.

The look-up API 120 refers to an application programming interface that allows users to retrieve information about specific entities or topics by providing an identifier or other identifying information. The look-up API 120 may be often used to access information that is stored in a database or other repository. For example, the lookup API 120 may allow the users to retrieve information about a specific tool or technique by providing a given name or other identifier for that tool or technique.

In operation, the processor 104 is configured to load the plurality of seed entities 112A to 112N in the memory 106. Specifically, the plurality of seed entities 112A to 112N is loaded in the memory 106 from the storage system 108.

The processor 104 is further configured to cause the look-up API 120 to search a first set of similar terms 124A to 124N for each seed entity of the plurality of seed entities 112A to 112N from the web-based database 118. In other words, a set of similar terms 124A is searched by the look-up API 120 for the seed entity 112A, another set of similar terms 122B is searched by the look-up API 120 for the seed entity 112B, and so on.

In an implementation, the first set of similar terms 124A to 124N for each seed entity of the plurality of seed entities 112A to 112N is searched from the web-based database 118 using page redirect information that is stored as an open knowledge graph in the web-based database 118. In other words, the first set of similar terms 124A to 124N includes a subset of similar terms that are related to a corresponding seed entity through the page redirect information. The open knowledge graph refers to a type of knowledge representation system that is designed to be openly available and accessible to anyone who wants to use it. The open knowledge graph may include a large, structured dataset that represents a wide range of concepts and relationships. The page redirect information refers to data that specifies which pages or articles in a web-based database or web resource should be redirected to other pages or articles when they are accessed.

In an implementation, the first set of similar terms 124A to 124N includes at least one of each similar term that redirects to a corresponding seed entity of the plurality of seed entities using the page redirect information. In other words, when one or more similar terms are accessed, it redirects to the seed entity. Such terms are included in the first set of similar terms 124A to 124N. In an example, if the seed entity is a technique known as “one factor at a time.” and there are several other terms in the database that redirect to the “one factor at a time” technique, then the first set of similar terms for the seed entity, “one factor at a time,” may include at least one of each of these terms that redirects to the “one factor at a time” technique. Some examples of such terms may include “OFaaT,” “OF@T,” “one variable at a time,” and “OVaaT”.

The first set of similar terms 124A to 124N further includes each similar term to which a corresponding seed entity of the plurality of seed entities redirects using the page redirect information. In other words, when the seed entity is accessed, the seed entity redirects to one or more similar terms. such one or more similar terms are included in the first set of similar terms 124A to 124N.

The first set of similar terms 124A to 124N further includes each similar term that redirects to the same term to which a corresponding seed entity of the plurality of seed entities redirects using the page redirect information. In other words, if the seed entity redirects to a term and one or more similar terms also redirects to the same term, the one or more similar terms are included in the first set of similar terms 124A to 124N.

In some examples, the similar terms in the web-based database 118 may be searched by using the page redirect information. This approach may be effective when the seed entity is spelled correctly, as it may allow the system 100 to find the correct information in the open knowledge graph and retrieve the desired results. However, it is possible that the first set of similar terms 124A to 124N may not include all similar terms for each seed entity if there are spelling mistakes in the seed entity. To address this issue, the system 100 may utilize the look-up API 120 to search for the first set of similar terms 124A to 124N in the web-based database 118 using the page redirect information. In cases where the seed entity is not spelled correctly, spell correction algorithms may be employed to ensure that the desired results are retrieved.

In order to cause the look-up API 120 to search the first set of similar terms 124A to 124N, the processor 104 is further configured to retrieve one or more candidate terms for each seed entity of the plurality of seed entities 112A to 112N from the web-based database 118 via the look-up API 120. The one or more candidate terms may include potentially similar terms for each seed entity of the plurality of seed entities 112A to 112N. Furthermore, the processor 104 is configured to apply a fuzzy match operation on the one or more candidate terms with respect to each seed entity to determine a fuzzy match score of each candidate term. A fuzzy match operation refers to a comparison that is used to determine the similarity or relatedness of two or more strings of text. In an implementation, the processor 104 is using the fuzzy match operation to compare the one or more candidate terms to each seed entity and determine the fuzzy match score for each candidate term. The fuzzy match score refers to a measure of how closely the candidate term matches the seed entity, with higher scores indicating a higher level of similarity. After that, the processor 104 is further configured to select the one or more candidate terms for each seed entity of the plurality of seed entities 112A to 112N to obtain the first set of similar terms 124A to 124N based on the fuzzy match score of each candidate term. The fuzzy match score of the first set of similar terms 124A to 124N for each seed entity ranges between 0.8-1. In some examples, the fuzzy match score of the first set of similar terms 124A to 124N for each seed entity may be at least 0.75, at least 0.7, at least 0.65, at least 0.6, at least 0.55, or at least 0.5.

The use of the fuzzy match operation and the fuzzy match scores may be useful for identifying potentially similar terms and improving the accuracy and comprehensiveness of the ontology 122. By comparing the candidate terms to the seed entities using the fuzzy match operation, the processor 104 may identify terms that are similar or related to the seed entity even if they are not an exact match. This may help to capture a wider range of information about the concept and improve the usability and user experience of the ontology 122.

In an implementation, the look-up API 120 searches the first set of similar terms 124A to 124N for each seed entity of the plurality of seed entities 112A to 112N from the web-based database 118 using format information disclosed in one or more web pages associated with each seed entity. In other words, the first set of similar terms 124A to 124N includes a subset of similar terms that are related to a corresponding seed entity through the format information. The format information refers to the way in which information is presented or displayed in a specific context. The format information may include various visual elements such as font size, typeface, color, and layout, as well as structural elements such as headings, lists, and tables. In this example, the format information disclosed in the web pages is indicative of one or more terms that are disclosed in the first paragraph of the web pages in a bold format. Specifically, the web pages related to the seed entity may be accessed and the one or more terms that are in the bold format in the first paragraph of the web page may be retrieved to include such terms in the first set of similar terms 124A to 124N.

The processor 104 is further configured to execute a first clustering of the first set of similar terms 124A-124N for each seed entity of the plurality of seed entities 112A to 112N based on a plurality of different concepts to obtain a first cluster of similar terms 126. The first cluster of similar terms 126 includes multiple clusters of similar terms classified based on the plurality of different concepts. Each cluster includes multiple similar terms for the plurality of seed entities 112A to 112N. Further, each cluster of similar terms may have a group of words or phrases that are related to a specific concept. The similar terms may be similar in meaning, spelling, or usage, and they may be used to describe the same or similar things. For example, a cluster of similar terms for a first concept may include synonyms, variant spellings, or other similar terms that are closely related to the main concept. For example, a cluster of similar terms for the concept “t test” may include terms like “t-test,” “student t test,” and “student t-test.”

The processor 104 is further configured to determine a second set of similar terms 128A to 128N for each seed entity of the plurality of seed entities 112A to 112N based on a category of each seed entity of the plurality of seed entities 112A to 112N. In other words, the category of a corresponding seed entity of the plurality of seed entity 112A to 112N may be same as the category of a corresponding second set of similar terms. In an example, if the seed entity 112A belongs to the category “animals,” the processor 104 may determine a second set of similar terms 128A that also belongs to the category “animals.” Similarly, if the seed entity 112B belongs to the category “plants.” the processor 104 may determine a second set of similar terms 128B that belongs to the category “plants.”

In order to determine the second set of similar terms 128A to 128N for each seed entity of the plurality of seed entities 112A to 112N based on the category of each seed entity, the processor 104 is further configured to filtering different categories of the plurality of seed entities based on a normalized inverse document frequency (IDFc) score of the category of each seed entity. The normalized IDFc score of the category of each seed entity is ranging from 0.5 to 0.6. Specifically, a collated type list is created by extracting the type information from the “type” category of the web based database 118 and collecting the type information into a single list. Further, for every term in the collated type list, categories of each term are retrieved to find the IDFc score for each category. The IDFc score of the category of each seed entity may be determined by the given equation provided below, and then the IDFc may be normalized by dividing the IDFc score with the maximum possible IDF score.

$${IDF}_{c} = log ( \frac{Number of terms}{N umber of terms having a same category} )$$

In order to determine the second set of similar terms 128A to 128N for each seed entity based on the category of each seed entity, the processor 104 is further configured to select the second set of similar terms 128A to 128N whose categories have the normalized IDFc scores ranging from 0.5 to 0.6. In some examples, the processor 104 may select the second set of similar terms 128A to 128N whose categories have the normalized IDFc scores ranging from 0.4 to 0.5, 0.3 to 0.4, 0.6 to 0.7, or 0.7 to 0.8.

In an implementation, in order to determine the second set of similar terms 128A to 128N for each seed entity of the plurality of seed entities 112A to 112N based on the category of each seed entity, the processor 104 is configure to select one or more phrases disclosed as hyperlinks in the web pages associated with each seed entity to obtain the second set of similar terms. The second set of similar terms have same categories as that of the one or more phrases disclosed as the hyperlinks. Specifically, the processor 104 may collate topics as hyperlinks in the webpages and select topics only if it is of the filtered type to obtain the second set of similar terms 128A to 128N. The filtered type topics may include similar terms whose categories have the normalized IDFc scores ranging from 0.5 to 0.6. Such topics may be identified as hyperlinks within the web pages.

The processor 104 is further configured to execute a second clustering of the second set of similar terms 128A to 128N for each seed entity based on the plurality of different concepts to obtain a second cluster of similar terms 130. The second cluster of similar terms 130 includes multiple clusters of similar terms classified based on the plurality of different concepts. Each cluster includes multiple similar terms for the plurality of seed entities 112A to 112N. Further, each cluster of similar terms may have a group of words or phrases that are related to a specific concept. The similar terms may be similar in meaning, spelling, or usage, and they may be used to describe the same or similar things. For example, a cluster of similar terms for a first concept may include new similar terms which belong to the same categories but are not present in the first set of similar terms 124A to 124N. For example, a cluster C1 may include a term “Hosmer-Lemeshow test,” a cluster C2 may include terms “Chi-squared test,” “Chi-square,” and “x2 test,” and a cluster C3 may include a term “Pearson's chi-squared test.” Although, the clusters C1, C2, C3 may be classified based on their relationship to specific concepts but the categories of the terms are the same.

The processor 104 is further configured to merge the first cluster of similar terms 126 and the second cluster of similar terms 130 to generate the ontology 122 of the plurality of seed entities 112A to 112N. The first cluster of similar terms 126 and the second cluster of similar terms 130 are merged to generate the ontology 122 of the plurality of seed entities 112A to 112N by using a union-find algorithm.

It should be noted that the first cluster of similar terms 126 and the second cluster of similar terms 130 may be merged by any clustering operation. In some examples, the executing of the first clustering and second clustering may be done by using the union-find algorithm or any other clustering operation.

In an implementation, to further populate the clusters, the processor 104 is further configured to retrieve a set of similar terms for each seed entity of the plurality of seed entities 112A to 112N from the web-based database 118 via the look-up API 120. The processor 104 is further configured to integrate the set of similar terms into the generated ontology 122. The processor 104 is further configured to iteratively perform operations of the retrieving and the integrating until a saturation point is reached. The saturation point being defined as the point where no new term is integrated in a final list of similar terms.

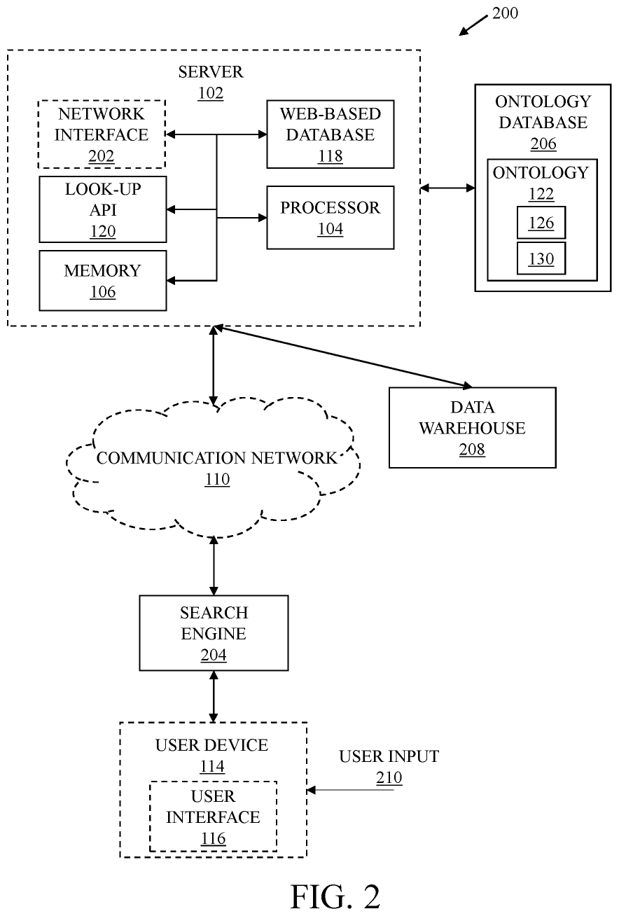

FIG. 2 is a block diagram of another system for generating an ontology for enhanced search, in accordance with an embodiment of the present disclosure. FIG. 2 is described in conjunction with elements from FIG. 1. With reference to FIG. 2, there is shown a block diagram of a system 200 that includes the server 102, the processor 104 and the memory 106.

The server 102 includes the processor 104 and the memory 106. The server 102 may further include a network interface 202. The network interface 202 is configured to communicate with the processor 104 and the memory 106. The system 200 further includes a search engine 204 communicatively connected to the server 102 and accessible by the user device 114, via the user interface 116 rendered on the user device 114. The system 200 is used to form an ontology database 206 based on the generated ontology 122. The system 200 further includes the ontology database 206 communicatively connected to the server 102. In an implementation, the ontology database 206 may be stored in the server 102. In some other implementations, the ontology database 206 may be stored outside the server 102, as shown in the system 200. The ontology database 206 includes the generated ontology 122. The system 200 further includes a data warehouse 208 communicatively connected to the server 102. In an implementation, the data warehouse 208 may be stored in the server 102. In some other implementations, the data warehouse 208 may be stored outside the server 102, as shown in the system 200. The data warehouse 208 includes multiple ontologies.

The network interface 202 refers to a communication interface to enable communication of the server 102 to any other external device, such as the user device 114. Examples of the network interface 202 include, but are not limited to, a network interface card, a transceiver, and the like.

The search engine 204 refers to a search platform to enable a user to carry out web searches. The search engine 204 uses the candidate identifiers of the one or more eligible candidates identified by the system 200 stored as metadata to improve search and retrieval capability.

In operations, the processor 104 is further configured to form the ontology database 206 based on the generated ontology 122. The processor 104 is further configured to integrate the ontology database 206 in the search engine 204.

In an implementation, the processor 104 is further configured to receive a user input 210 of one or more words in the search engine 204. The processor 104 is further configured to retrieve each similar term or unstructured text related to the one or more words. The one or more words is searched in the generated ontology 122 in order to find each similar term or the unstructured text related to the one or more words. In other implementations, the generated ontology 122 of the plurality of seed entities 112A to 112N includes each similar term associated with the plurality of seed entities 112A to 112N. Each similar term associated with the plurality of seed entities 112A to 112N is accessible from the generated ontology 122 by the processor 104 using the search engine 204.

In an implementation, the processor 104 is further configured to form the data warehouse 208 of the plurality of seed entities for the search engine 204 based on performing semantic tagging of a plurality of given lists of seed entities. The data warehouse 208 refers to a large, centralized repository of data that is used for data analysis and reporting. Data warehouses are designed to support efficient querying and analysis of data, and are typically used to support business decision-making, data mining, and analytics. The data warehouse 208 may be configured to store multiple ontologies based on performing the semantic tagging of the plurality of given lists of seed entities.

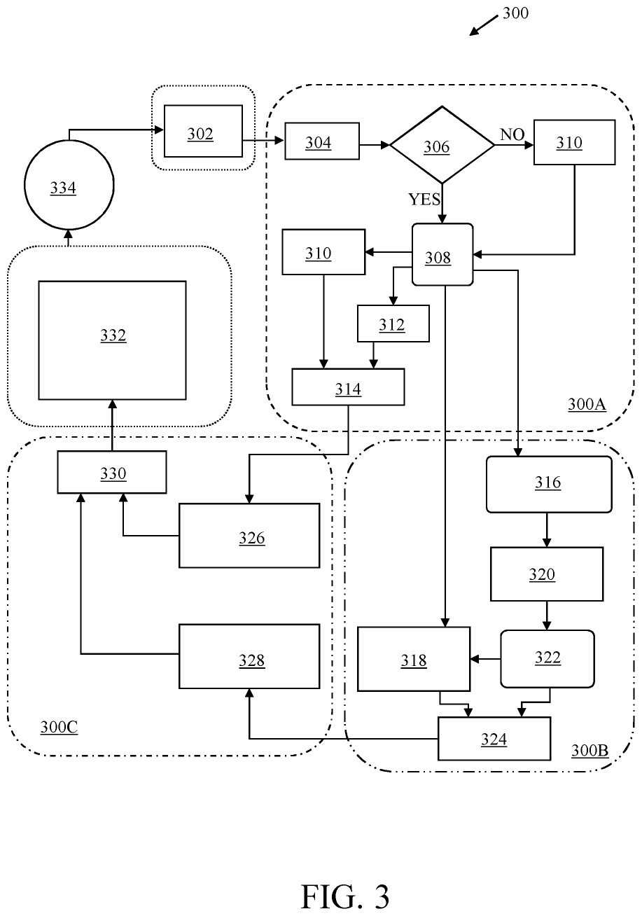

FIG. 3 depicts a flowchart for generating an ontology for enhanced search, in accordance with an embodiment of the present disclosure. FIG. 3 is described in conjunction with elements from FIGS. 1 and 2. With reference to FIG. 3, there is shown a flowchart 300 that includes a series of operations from 302-to-334. The flowchart 300 further includes a first process 300A, a second process 300B, and a third process 300C. The processor 104 (of FIG. 1) is configured to execute the flowchart 300.

At operation 302, the processor 104 is configured to load the plurality of seed entities 112A to 112N. Thereafter, at operation 304, the processor 104 is further configured to use the look-up API 120 for each seed entity. Further, at operation 306, the processor 103 is further configured to check whether the page link exists with the same term for each seed entity. If the page link exists with the same term, the process will reach operation 308. If the page link may not exist with the same term, the process will reach operation 310. At operation 310, the processor 104 is further configured to find nearest matching term similarity using the fuzzy match operation. If the fuzzy match score of the similar term corresponding to the seed entity is greater than 0.8, the process will again reach operation 308. At operation 308, the processor 104 is further configured to collate web page links associated with the seed entity and open the web-based database 118 and the web pages associated with the seed entity. After that, at operation 310, the processor 104 is further configured to retrieve similar terms using page redirect information from the web-based database 118. Parallelly, at operation 312, the processor 104 is further configured to retrieve similar terms in bold format from the first paragraph of the web pages. Further, at operation 314, results of the operations 310 and 312 are merged together using the union find algorithm or any other clustering algorithm to obtain the first cluster of similar terms 126. Merging the results of the operations 310 and 312 depicts the first process 300A of the flowchart 300.

After the operation 308 of the first process 300A, the process will reach operations 316 and 318. At operation 316, the processor 104 is further configured to collate type information from the web-based database 118 to obtain a collated type list depicting categories of the seed entities 112A to 112N. Thereafter, at operation 320, the processor 104 is further configured to apply IDF on the collated type list. After that, at operation 322, the processor 104 is further configured to filter the collated type list based on the IDFc score and retrieve the new similar terms whose categories have the IDFc score ranging from 0.5 to 0.6. Further, at operation 318, the processor 104 is further configured to collate similar terms as hyperlinks in the web pages and select the new similar terms whose categories have the IDFc score ranging from 0.5 to 0.6. at operation 324, the processor 104 is further configured to merge the results of the operation 318 and 322 to obtain the second cluster of similar terms 130. Merging the results of the operations 318 and 322 depicts the second process 300B of the flowchart 300.

After the operation 314 of the first process 300A, at operation 326, the processor 104 is further configured to obtain the first cluster of similar terms 126. Further, after the operation 324 of the second process 300B, at operation 328, the processor 104 is further configured to obtain the second cluster of similar terms 130. After that, at operation 330, the processor 104 is further configured to merge the first cluster of similar terms 126 and the second cluster of similar terms 130 to obtain a single cluster. Merging the results of the operations 326 and 328 depicts the third process 300C of the flowchart 300.

Consequently, at operation 332, the processor 104 is further configured to generate the ontology 122 by used the single cluster formed at the operation 330. Moreover, at operation 334, the processor 104 is further configured to repeat the first, second and third processes 300A, 300B, 300C and use the similar terms in the single cluster formed at the operation 330 as a plurality of seed entities to re-iterate until a saturation point is reached. Specifically, at the operation 332, a final list of similar terms that have been identified and grouped together through the above iterative process. The final list of similar terms serves as an input for the next iteration of the process, in which additional similar terms may be identified and added to the final list. The iteration continues until the saturation point is reached, which may be a point at which no new terms qualify a threshold or there may be no change in the final list of similar terms of the generated ontology 122. The threshold refers to a predetermined criterion that may be met in order for a term to be included in the final list. The predetermined criterion may be based on the similarity of the term to the seed entity, the frequency of the term in the data, or some other measure.

Advantageously, the iterative process may be used to identify as many similar terms as possible for each seed entity, and to group similar terms into clusters based on their similarity and relevance to the seed entity. The process continues until it reaches a saturation point, at which point it is considered to have identified all of the relevant similar terms for the seed entity.

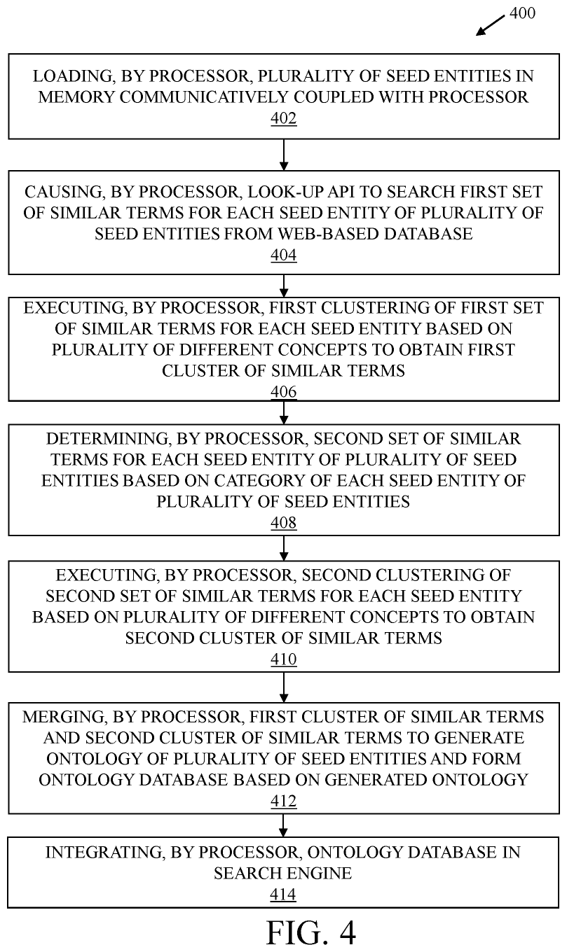

FIG. 4 is a flowchart of a method for generating an ontology for enhanced search, in accordance with an embodiment of the present disclosure. FIG. 4 is explained in conjunction with elements from FIGS. 1, 2, and 3. With reference FIG. 4, there is shown a flowchart of a method 400. The method 400 is executed at the server 102 (of FIG. 1). The method 400 may include steps 402 to 410.

At step 402, the method 400 includes loading, by the processor 104, the plurality of seed entities 112A to 112N in the memory 106 communicatively coupled with the processor 104. The seed entities 112A to 112N loaded in the memory 106 may be manually or automatically selected by the user or the processor 104, respectively.

At step 404, the method 400 further includes causing, by the processor 104, the look-up API 120 to search the first set of similar terms 124A to 124N for each seed entity of the plurality of seed entities 112A to 112N from the web-based database 118. The look-up API 120 may be used to search for similar terms that may have a slight variation of spelling.

In accordance with an embodiment, the causing of the look-up API 120 to search the first set of similar terms 124A to 124N includes retrieving one or more candidate terms for each seed entity of the plurality of seed entities 112A to 112N from the web-based database 118 via the look-up API 120, applying the fuzzy match operation on the one or more candidate terms with respect to each seed entity to determine the fuzzy match score of each candidate term, and selecting the one or more candidate terms for each seed entity of based on the fuzzy match score of each candidate term to obtain the first set of similar terms 124A to 124N. The fuzzy match score of the first set of similar terms for each seed entity ranges between 0.8-1.

In accordance with an embodiment, the causing of the look-up API 120 to search the first set of similar terms 124A to 124N includes searching the first set of similar terms 124A to 124N for each seed entity of the plurality of seed entities 112A to 112N from the web-based database 118 using page redirect information that is stored as an open knowledge graph in the web-based database 118.

In accordance with an embodiment, the searching of the first set of similar terms 124A to 124N for each seed entity from the web-based database 118 using the page redirect information includes searching each similar term that redirects to a corresponding seed entity of the plurality of seed entities 112A to 112N using the page redirect information.

In accordance with an embodiment, the searching of the first set of similar terms 124A to 124N for each seed entity from the web-based database 118 using the page redirect information includes searching each similar term to which a corresponding seed entity of the plurality of seed entities 112A to 112N redirects using the page redirect information.

In accordance with an embodiment, the searching of the first set of similar terms 124A to 124N for each seed entity from the web-based database 118 using the page redirect information includes searching each similar term that redirects to a same term to which a corresponding seed entity of the plurality of seed entities 112A to 112N redirects using the page redirect information.

In accordance with an embodiment, the causing of the look-up API 120 to search the first set of similar terms 124A to 124N includes searching the first set of similar terms 124A to 124N for each seed entity using format information disclosed in one or more web pages associated with each seed entity. The format information disclosed in the web pages is indicative of one or more terms that are disclosed in a first paragraph of the web pages in a bold format.

At step 406, the method 400 further includes executing, by the processor 104, the first clustering of the first set of similar terms 124A to 124N for each seed entity based on the plurality of different concepts to obtain the first cluster of similar terms 126. The first cluster of similar terms 126 may include all similar terms that may be synonyms, abbreviations, and the like.

At step 408, the method 400 further includes determining, by the processor 104, the second set of similar terms 128A to 128N for each seed entity of the plurality of seed entities 112A to 112N based on the category of each seed entity of the plurality of seed entities 112A to 112N. The second set of similar terms 128A to 128N may include similar terms having same categories. Thus, the second set of similar terms 128A to 128N are classified based on the categories of the plurality of seed entities 112A to 112N.

In accordance with an embodiment, the determining of the second set of similar terms 128A to 128N for each seed entity of the plurality of seed entities 112A to 112N based on the category of each seed entity includes filtering different categories of the plurality of seed entities 112A to 112N based on the normalized inverse document frequency (IDFc) score of the category of each seed entity. The normalized IDFc score of the category of each seed entity is ranging from 0.5 to 0.6. The determining of the second set of similar terms 128A to 128N for each seed entity of the plurality of seed entities 112A to 112N based on the category of each seed entity further includes selecting the second set of similar terms 128A to 128N whose categories have the normalized IDFc scores ranging from 0.5 to 0.6.

In accordance with an embodiment, the determining of the second set of similar terms 128A to 128N for each seed entity of the plurality of seed entities 112A to 112N based on the category of each seed entity includes selecting one or more phrases disclosed as hyperlinks in the web pages associated with each seed entity to obtain the second set of similar terms 128A to 128N. The second set of similar terms 128A to 128N has same categories as that of the one or more phrases disclosed as the hyperlinks.

At step 410, the method 400 further includes executing, by the processor 104, the second clustering of the second set of similar terms 128A to 128N for each seed entity based on the plurality of different concepts to obtain the second cluster of similar terms 130. The second cluster of similar terms 130 may include similar terms that are non-synonyms but have same categories.

At step 412, the method 400 further includes merging, by the processor 104, the first cluster of similar terms 126 and the second cluster of similar terms 130 to generate the ontology 122 of the plurality of seed entities 112A to 112N and form the ontology database 206 based on the generated ontology 122. The generated ontology 122 may include all the similar terms for the given list of seed entities.

At step 414, the method 400 further includes integrating, by the processor 104, the ontology database 206 in the search engine 204. The accuracy of search may be improved by using the ontology 122 to organize and categorize the information in database of the search engine 204.

In accordance with an embodiment, the method 400 further includes an iterative process of retrieving a set of similar terms for each seed entity of the plurality of seed entities 112A to 112N from the web-based database 118 via the look-up API 120. The method 400 further includes the iterative process of integrating the set of similar terms into the generated ontology 122. The method 400 further includes the iterative process of iteratively performing operations of the retrieving and the integrating until a saturation point is reached. The saturation point being defined as the point where no new term is integrated in a final list of similar terms. The final list of similar terms is identified and grouped together through the above iterative process/method. The final list of similar terms disclosed in the generated ontology 122 serves as an input for the next iteration of the process, in which additional similar terms may be identified and added to the final list. The iteration continues until the saturation point is reached. In some examples, the method 400 may further includes identifying as many similar terms as possible for each seed entity, and to group similar terms into clusters based on their similarity and relevance to the seed entity.

In accordance with an embodiment, the method 400 further includes forming, by the processor 104, the data warehouse 208 of the plurality of seed entities 112A to 112N for the search engine 104 based on performing semantic tagging of the plurality of given lists of seed entities. In accordance with an embodiment, the method 400 further includes receiving, by the processor 104, the user input 210 of the one or more words in the search engine 204. The method 400 further includes retrieving, by the processor 104, each similar term or unstructured text related to the one or more words. The one or more words is searched in the generated ontology 122 in order to find each similar term or the unstructured text related to the one or more words.

The systems 100, 200 and the method 400 disclosed in the present disclosure allows for the creation of the ontology 122 that may be used to organize and categorize concepts, synonyms, and alternate terms within a particular domain of knowledge. The generated ontology 122 may then be integrated into the search engine 204, making it easier for researchers and scientists to find and understand the relationships between different concepts and terms within their field. Another advantage of the systems 100, 200 and the method 400 of the present disclosure is that the systems 100, 200 and the method 400 may help researchers to identify and discover new tools, techniques, and concepts that are related to their work. This may be especially useful for researchers who are working in rapidly-evolving fields, where new technologies and approaches are being developed all the time.

Further, the use of the generated ontology 122 as described in the systems 100, 200 and the method 400 of the present disclosure may help to improve the efficiency and effectiveness of scientific research, by providing a more organized and comprehensive view of the concepts and tools that are relevant to a particular field of study.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A method of generating an ontology for enhanced search, the method comprising:
loading, by a processor, a plurality of seed entities in a memory communicatively coupled with the processor;
causing, by the processor, a look-up application programming interface (API) to search a first set of similar terms for each seed entity of the plurality of seed entities from a web-based database;
executing, by the processor, a first clustering of the first set of similar terms for each seed entity based on a plurality of different concepts to obtain a first cluster of similar terms;
determining, by the processor, a second set of similar terms for each seed entity of the plurality of seed entities based on a category of each seed entity of the plurality of seed entities;
executing, by the processor, a second clustering of the second set of similar terms for each seed entity based on the plurality of different concepts to obtain a second cluster of similar terms;
merging, by the processor, the first cluster of similar terms and the second cluster of similar terms to generate the ontology of the plurality of seed entities and forming, by the processor, an ontology database based on the generated ontology; and
integrating, by the processor, the ontology database in a search engine.

2. The method according to claim 1, wherein the causing of the look-up API to search the first set of similar terms comprises:
retrieving one or more candidate terms for each seed entity of the plurality of seed entities from the web-based database via the look-up API;
applying a fuzzy match operation on the one or more candidate terms with respect to each seed entity to determine a fuzzy match score of each candidate term; and
selecting the one or more candidate terms for each seed entity of the plurality of seed entities based on the fuzzy match score of each candidate term to obtain the first set of similar terms,
wherein the fuzzy match score of the first set of similar terms for each seed entity ranges between 0.8-1.

3. The method according to claim 1, wherein the causing of the look-up API to search the first set of similar terms comprises searching the first set of similar terms for each seed entity of the plurality of seed entities from the web-based database using page redirect information that is stored as an open knowledge graph in the web-based database.

4. The method according to claim 3, wherein the searching of the first set of similar terms for each seed entity from the web-based database using the page redirect information comprises searching each similar term that redirects to a corresponding seed entity of the plurality of seed entities using the page redirect information.

5. The method according to claim 3, wherein the searching of the first set of similar terms for each seed entity from the web-based database using the page redirect information comprises searching each similar term to which a corresponding seed entity of the plurality of seed entities redirects using the page redirect information.

6. The method according to claim 3, wherein the searching of the first set of similar terms for each seed entity from the web-based database using the page redirect information comprises searching each similar term that redirects to a same term to which a corresponding seed entity of the plurality of seed entities redirects using the page redirect information.

7. The method according to claim 1, wherein the causing of the look-up API to search the first set of similar terms comprises searching the first set of similar terms for each seed entity using format information disclosed in one or more web pages associated with each seed entity, wherein the format information disclosed in the web pages is indicative of one or more terms that are disclosed in a first paragraph of the web pages in a bold format.

8. The method according to claim 1, wherein the determining of the second set of similar terms for each seed entity of the plurality of seed entities based on the category of each seed entity comprises:
filtering different categories of the plurality of seed entities based on a normalized inverse document frequency (IDFc) score of the category of each seed entity, wherein the normalized IDFc score of the category of each seed entity is ranging from 0.5 to 0.6; and
selecting the second set of similar terms whose categories have the normalized IDFc scores ranging from 0.5 to 0.6.

9. The method according to claim 1, wherein the determining of the second set of similar terms for each seed entity of the plurality of seed entities based on the category of each seed entity comprises selecting one or more phrases disclosed as hyperlinks in the web pages associated with each seed entity to obtain the second set of similar terms, the second set of similar terms having same categories as that of the one or more phrases disclosed as the hyperlinks.

10. The method according to claim 1, further comprising an iterative process of:
retrieving a set of similar terms for each seed entity of the plurality of seed entities from the web-based database via the look-up API;
integrating the set of similar terms into the generated ontology; and
iteratively performing operations of the retrieving and the integrating until a saturation point is reached, the saturation point being defined as the point where no new term is integrated in a final list of similar terms, wherein the final list of similar terms serves as a new input list for the next iteration of the iterative process.

11. The method according to claim 1, further comprising forming, by the processor, a data warehouse of the plurality of seed entities for the search engine based on performing semantic tagging of a plurality of given lists of seed entities.

12. The method according to claim 11, further comprising:
receiving, by the processor, a user input of one or more words in the search engine; and
retrieving, by the processor, each similar term or unstructured text related to the one or more words, wherein the one or more words is searched in the generated ontology in order to find each similar term or the unstructured text related to the one or more words.

13. A system for generating an ontology for enhanced search, the system comprising:
a memory; and
a processor communicatively coupled with the memory, wherein the processor is configured to:
load a plurality of seed entities in the memory;
cause a look-up application programming interface (API) to search a first set of similar terms for each seed entity of the plurality of seed entities from a web-based database;
execute a first clustering of the first set of similar terms for each seed entity of the plurality of seed entities based on a plurality of different concepts to obtain a first cluster of similar terms;
determine a second set of similar terms for each seed entity of the plurality of seed entities based on a category of each seed entity of the plurality of seed entities;
execute a second clustering of the second set of similar terms for each seed entity based on the plurality of different concepts to obtain a second cluster of similar terms;
merge the first cluster of similar terms and the second cluster of similar terms to generate the ontology of the plurality of seed entities and form an ontology database based on the generated ontology; and
integrate the ontology database in a search engine.

14. The system according to claim 13, wherein, in order to cause the look-up API to search the first set of similar terms, the processor is further configured to:
retrieve one or more candidate terms for each seed entity of the plurality of seed entities from the web-based database via the look-up API;
apply a fuzzy match operation on the one or more candidate terms with respect to each seed entity to determine a fuzzy match score of each candidate term; and
select the one or more candidate terms for each seed entity of the plurality of seed entities to obtain the first set of similar terms based on the fuzzy match score of each candidate term,
wherein the fuzzy match score of the first set of similar terms for each seed entity ranges between 0.8-1.

15. The system according to claim 13, wherein in order to determine the second set of similar terms for each seed entity of the plurality of seed entities based on the category of each seed entity, the processor is further configured to:
filter different categories based a normalized inverse document frequency (IDFc) score of the category of each seed entity of the plurality of seed entities, wherein the normalized IDFc score of the category of each seed entity of the plurality of seed entities is ranging from 0.5 to 0.6; and
select the second set of similar terms whose categories have the normalized IDFc scores ranging from 0.5 to 0.6.

16. The system according to claim 13, wherein the first set of similar terms comprises at least one of each similar term that redirects to a corresponding seed entity of the plurality of seed entities using the page redirect information, each similar term to which a corresponding seed entity of the plurality of seed entities redirects using the page redirect information, and each similar term that redirects to a same term to which a corresponding seed entity of the plurality of seed entities redirects using the page redirect information.

17. The system according to claim 13, wherein the first cluster and the second cluster are merged to generate the ontology of the plurality of seed entities by using a union-find algorithm.

18. The system according to claim 13, wherein the processor is further configured to form a data warehouse of the plurality of seed entities for the search engine based on performing semantic tagging of a plurality of given lists of seed entities.

19. The system according to claim 13, wherein the processor is further configured to:
receive a user input of one or more words in the search engine; and
retrieve each similar term or unstructured text related to the one or more words, wherein the one or more words is searched in the generated ontology in order to find each similar term or the unstructured text related to the one or more words.

20. The system according to claim 13, wherein the generated ontology of the plurality of seed entities comprises each similar term associated with the plurality of seed entities, and wherein each similar term associated with the plurality of seed entities is accessible from the generated ontology by the processor using the search engine.
